(19) United States
(12) Patent Application Publication
(10) Pub. No.: US 2011/0085756 A1
(43) Pub. Date: Apr. 14, 2011

(54) SWING BEARING AND METHOD OF PROCESSING RACEWAY GROOVE OF THE SAME

(75) Inventors: Michio Hori, Mie (JP); Nurumu Kuwahara, Mie (JP); Yoshifumi Yamamoto, Mie (JP)

(73) Assignee: NTN CORPORATION, OSAKA (JP)

(21) Appl. No.: 12/737,043

(22) PCT Filed: Jun. 5, 2009
(86) PCT No.: PCT/JP2009/002545

§ 371 Date: Dec. 3, 2010

(30) Foreign Application Priority Data
Jun. 6, 2008 (JP) 2008-149124
May 7, 2009 (JP) 2009-112561
Jun. 3, 2009 (JP) 2009-133628

(51) Int. Cl. F16C 33/58; B23P 17/00; B24B 1/00

(52) U.S. Cl. 384/513; 29/898.066; 451/52

(57) ABSTRACT

A swing bearing assembly includes a plurality of balls (3) interposed between double row raceway grooves (1a, 1b, 2a, 2b) in inner and outer rings (1, 2). The distance (ei) between the double row raceway grooves in the inner ring or the distance (eo) between the double row raceway grooves in the outer ring is within the range of a value equal to the diameter (Dw) of each of the balls to a value 1.7 times the diameter (Dw) and the diameter (Dw) of each of the balls is within the range of 30 to 80 mm, with the difference (Δe) between the raceway groove distance (ei) and the raceway groove distance (eo) chosen to be within the range of 5 to 50 μm. The double row raceway grooves are simultaneously processed with the use of alundum series grindstones.

### CROSS REFERENCE TO THE RELATED APPLICATION

This application is based on and claims Convention priority to Japanese patent applications No. 2008-149124, filed Jun. 6, 2008, No. 2009-112561, filed May 7, 2009, and No. 2009-133628, filed Jun. 3, 2009, the entire disclosures of which are herein incorporated by reference as a part of this application.

### BACKGROUND OF THE INVENTION

The present invention relates to a large-sized or supersized swing bearing assembly for use in a swivel mechanism employed for, for example, a blade assembly of a wind power generator and a method of forming a raceway groove employed in such bearing assembly.

FIGS. 8 and 9 illustrate one example of a wind turbine utilizing a blade assembly for power generation by wind. The blade assembly 11 shown therein includes a nacelle 13 mounted on a support base 12 for angular movement in a horizontal plane, a horizontally extending main shaft 15 rotatably supported within a nacelle casing 14 forming a part of the nacelle 13, a blade assembly 11 including a plurality of three rotor blades 16 mounted on one end of the main shaft 15, which protrudes outwardly of the casing 14, for rotation together therewith. The opposite end of the main shaft 15 is drivingly coupled with a speed increasing gear unit 17 having an output shaft 18 which is in turn drivingly coupled with a rotor shaft of a power generator 19.

The blade assembly 11 employed for electric power generator by wind is large in scale and even the single rotor blade 16 generally extends a length of several tens meters, and in some assemblies in excess of 100 meters. For this reason, when the blade assembly 11 rotates together with the main shaft 15, the rotor blades 16 are subjected to different wind velocities depending on the position of the particular rotor blade 16 with respect to the direction of rotation thereof, for example, whether the rotor blade 16 being rotated assumes a top position or a bottom position with respect to the main shaft 15. Accordingly, care is generally taken to adjust the angle of attack of each of the rotor blades 16 relative to the incoming wind, according to the wind velocity during the rotation of the blade assembly 11 so that even though the wind velocities acting on those rotor blades 16 are different from each other, all of those rotor blades 16 can be equally loaded. Also, in order for each of those rotor blades 16 to receive the wind that is incoming head-on towards the blade assembly 11, it is a general practice to change the orientation (yaw angle) of the nacelle 13 according to change in wind direction. It may, however, occur that where there is a risk that the rotor blades 16 may be excessively loaded in the face of the wind velocity being too high, the orientation of the nacelle 13 is reversed relative to a normal orientation in which the rotor blades 16 rotate to generate power, to thereby allow the incoming wind to pass across the blade assembly 11.

As discussed above, in the blade assembly employed in the wind turbine for generation of electricity by wind, the angle of attack of each of the rotor blades 16 and the orientation, i.e., the yaw angle, of the nacelle 13, are necessarily changed according to the condition of the wind then blowing. Accordingly, each of the rotor blades 16 and the nacelle 13 are rotatably supported by respective swing bearing assemblies 21 and 22 so that the rotor blades 16 and the nacelle 13 can be driven by associated drive means (not shown). Each of those swing bearing assemblies used in the wind turbine is generally characteristically, inter alia, very large in size, relatively small in angle of pivot during the swing or in the yaw angle, and susceptible to a varying load.

Specifically, regarding the size, the swing bearing assembly 21 used for rotatably supporting each of the rotor blades for adjustment of the angle of attack has an outer ring ranging from 1,000 to 3,000 mm in outer diameter and the swing bearing assembly 22 used for rotatably supporting the nacelle 13 for adjustment of the orientation thereof relative to the incoming wind has an outer ring ranging from 1,500 to 3,500 mm in outer diameter. On the other hand, regarding the angle of pivot, each of the rotor blades 16 is required to pivot about 90° at maximum and the nacelle 13 is required to pivot 360° at maximum. In any event, although the bearing assemblies for the adjustment of the angle of attack of each of the rotor blades and the adjustment of the orientation of the nacelle are both susceptible to the varying load, it is the bearing assembly employed in each of the rotor blades 16 that receives an abruptly varying load so often.

In a wide range of fields of, for example, construction machines and machine tools, the swing bearing assembly is generally employed in the form of a four point contact ball bearing. The four point contact ball bearing referred to above makes use of an inner ring and an outer ring each having a raceway groove composed of two curved surfaces with a plurality of balls rollingly interposed between those raceway grooves. Since the balls are firmly sandwiched between the raceway grooves and each of the inner and outer races has a high rigidity, a large load carrying capacity can be obtained with a simplified structure.

### Patent Document

JP Laid-open Patent Publication No. H06-143136

In view of the foregoing, an attempt has been made to employ double rows of four point contact ball bearings, as shown in FIG. 10, in the swing bearing assembly for use in the wind turbine, of a type which is large sized or supersized and requires a large load rating. It is, however, to be noted that according to JIS (Japanese Industrial Standard) B 0104-1991, the large sized bearing is defined as having an outer ring of an outer diameter ranging from 180 to 800 mm. In such case, the following may be concerned. That is to say, when an external load is imposed on the bearing assembly, the balance of loads acting on contact points P of the balls 3 with the inner and outer races 1 and 2 will become uneven to such an extent as to result in reduction in service life.

As a cause for the uneven load balance, deformation of the raceway grooves 1a and 1b of the inner and outer raceways 1 and 2 has been pointed out. Factors affecting the deformation of the raceway grooves are many and Patent Document 1 listed above discloses countermeasures against those factors. By way of example, it is described that, with respect to bearing gaps, in order to equalize the loads loaded on the rows, the difference between gaps (amounts of preloads) in those rows may be determined according to the amount of deformation.

Also, getting another perspective on the concern, as another factor, the difference between the distance ei between the double row raceway grooves 1a and 1b in the inner ring 1 and the distance eo between the double row raceway grooves 2a and 2b in the outer ring 2 can be enumerated.

The method of measuring each of those distances ei and eo will now be discussed. In the case of the inner ring groove, while steel balls used in the double row raceway grooves 1a and 1b are radially urged (so as to contact at two points 1aa and 1ab in the case of the raceway groove 1a and at two points 1ba and 1bb in the case of the raceway groove 1b), the respective inter-ball axial distances thereof are measured to ascertain the distance ei (ei=Measured Value+Steel Ball Diameter). The inter-ball axial distance referred to above means the axially measured shortest distance between two steel balls which have been urged against the respective raceway grooves 1a and 1b. Measurement similar to the above in connection with the inner raceway rings is carried out to the outer raceway rings to ascertain the distance eo.

It can be suspected that if the relative difference Δe between the inter-raceway groove distances ei and eo (i.e., Δe=eo−ei) is large, the relative difference between the bearing gaps increases correspondingly, and, therefore, the unevenness in load balance increases. The relative difference Δe between those inter-raceway groove distances affects the load balance regardless of the rigidity on the side of a bearing mounting surface. That is because, while displacement brought about by the load may supposedly include expansion, shrinkage and torsion, those bring no influence on the relative difference Δe. In other words, the relative difference Δe between the inter-raceway groove distances is a prime factor that brings about the biggest influence on the unevenness of the load balance and, therefore, the inventors found that it is very important to control the relative difference Δe. It is incidentally to be noted that the Patent Document 1 referred to previously makes no mention of the inter-raceway groove distances ei and eo and the relative difference Δe.

In order to maximize the bearing lifetime, it is ideal that the relative difference Δe between the inter-raceway distances is zero. In reality, however, to realize that the zero relative difference Δe is impossible and even an attempt to render the relative difference Δe to approach zero wherever possible is difficult to accomplish when considering the productivity and the cost. Accordingly, it is realistic to determine the relative difference Δe between the inter-raceway groove distances with due regards paid to the balance between productivity and cost.

### SUMMARY OF THE INVENTION

An object of the present invention is to provide the relative difference between the inter-raceway groove distances in a swing bearing assembly having double row raceway grooves, which difference can results in an increase of the bearing lifetime at such a cost that will not affect the productivity to the extent possible.

Another object of the present invention is to provide an inter-raceway groove processing method capable of accurately and efficiently processing the raceway grooves in the swing bearing assembly of a kind referred to above.

The swing bearing assembly to which the present invention pertain is of such a design in which double row raceway grooves are formed in each of inner and outer rings, with a plurality of balls interposed rollingly between the double row raceway grooves in the inner ring and the double row raceway grooves in the outer ring, respectively. Each of the inner and outer rings employed in the swing bearing assembly is of one-piece construction and the difference between the distance from one row of the raceway groove in the inner ring to another row of the raceway groove in the inner ring and the distance from one row of the raceway groove in the outer ring to another row of the raceway groove in the outer ring is chosen to be not greater than 50 μm.

It is to be noted that the term “one-piece structure” used in connection with the inner ring or outer rings in the description made hereinabove and hereinafter is to be understood as meaning that the inner or outer ring is made of unitary raw material in the form as having the double row raceway grooves, and does not include any inner or outer ring comprised of a plurality of component parts bonded, welded and/or connected together in any way whatsoever.

In the swing bearing assembly of a type in which double row raceway grooves are formed in each of the inner and outer rings, a plurality of swing bearing assemblies, in which each of the inner and outer rings is of one-piece structure and which have different differences between the inter-raceway groove distance in the inner ring and the inter-raceway groove distance in the outer ring were manufactured and the lifetime of each of those swing bearing assemblies so manufactured was measured. As a result, it has been found that if the difference between the inter-raceway groove distance in the inner ring and the inter-raceway groove distance in the outer ring is chosen to be of a value equal to and smaller than 50 μm, there is no problem in the lifetime of the swing bearing assembly when the durability of the wind turbine as a whole is taken into consideration.

As a result of measurement of each of the plurality of the swing bearing assemblies having the different difference (hereinafter referred to as “relative difference between the inter-raceway groove distances”) between the inter-raceway groove distance in the inner ring and the inter-raceway groove distance in the outer ring, selection of the relative difference between the inter-raceway groove distances of a value greater than 50 μm, it has been found that a problem has arisen in the lifetime of the swing bearing assembly when the durability of the wind turbine as a whole is taken into consideration. In view of the above, it has been concluded that the relative difference between the inter-raceway groove distances should be of a value equal to or smaller than 50 μm. It is to be noted that considering that in the large sized or supersized swing bearing assembly used in the swivel mechanism in the wind turbine system, maintenance-free is required, the relative difference between the inter-raceway groove distances is preferably of a value equal to or smaller than 20 μm as this value makes it possible to increase the lifetime further. In addition, if the relative difference between the inter-raceway groove distances is made smaller than 5 μm, the productivity will be reduced and the cost will increase to such an extent that the swing bearing assembly will no longer pay and, therefore, selection of the relative difference between the inter-raceway grooves within the range of values, which are equal to or greater than 5 μm, is preferable.

The distance between the double row raceway grooves in the inner ring or the distance between the double row raceway grooves in the outer ring may be chosen to fall within the range of a value equal to the diameter of each of the ball to a value that is 1.7 times the diameter of each of the balls having a diameter within the range of 30 to 80 mm. In this condition, the plurality of the swing bearing assemblies having the different relative difference between the inter-raceway groove distances can be manufactured and the lifetime thereof can be measured.

A forming or processing method for raceway grooves of a swing bearing assembly according to the present invention is such that the double row raceway grooves are formed in each of inner and outer rings, which is of one-piece structure, and a plurality of balls are interposed between the double row raceway grooves in the inner ring and the double row raceway grooves in the outer ring, respectively, and that the double row raceway grooves in the inner ring and the double row raceway grooves in the outer ring are simultaneously processed to reduce the difference between the distance from one row of the raceway groove in the inner ring to another row of the raceway groove in the inner ring and the distance from one row of the raceway groove in the outer ring to another row of the raceway groove in the outer ring to a value equal to or smaller than 50 μm.

It is to be noted that the wording “to be simultaneously processed” referred to above and hereinafter is to be construed as meaning that the double row raceway grooves are processed parallel with the use of a plurality of grindstones mounted on the same shaft.

If as suggested by the foregoing raceway groove processing method, the double row raceway grooves in the inner and outer rings are processed simultaneously, there is no possibility of occurrence of an error in mechanical accuracy and preciseness of the feeding for those double rows such as found in the case where those row raceway grooves in the inner and outer rings are processed separately in different process steps, and, hence, the preciseness of the inter-raceway groove distance is high. For this reason, the relative difference between the inter-raceway groove distances can be suppressed. In addition, simultaneous processing of the double rows of the raceway grooves results in a high processing efficiency. The swing bearing assembly having the raceway grooves, which have been processed by the raceway groove processing method of the present invention has a small relative difference between the inter-raceway groove distances and, therefore, the load can be uniformly imposed on the double row raceway grooves, thus making it possible to increase the lifetime.

The distance from one row of the raceway groove in the inner ring to another row of the raceway groove in the inner ring or the distance from one row of the raceway groove in the outer ring to another row of the raceway groove in the outer ring may be chosen to fall within the range of a value equal to the diameter of each of the ball to a value that is 1.7 times the diameter of each of the balls. In this case, each of the balls preferably has a diameter within the range of 30 to 80 mm.

The raceway grooves may be processed by the use of an alundum series grindstone. In this case, the shoulder height of the raceway grooves can be selected to such a sufficiently required value as to avoid a so-called shoulder run-on. Although as the shoulder height of the raceway grooves increases, points of contact of the grindstone shifts from an outer diametric portion, at which the peripheral velocity is high, to an end face at which the peripheral velocity is low, an undesirable excessive temperature rise during the processing of the raceway grooves can be avoided beforehand if the alundum series grindstones are used and other processing conditions are satisfied at the same time. The alundum series is soft as compared with the ceramic series. For this reason, scoring or scuffing can be avoided.

The term “alundum” referred to hereinabove is synonymous with an alumina series grindstone. The term “shoulder run-on” referred to above is intended to means the phenomenon, in which when an axially acting load is imposed on the bearing assembly, the contact ellipse appearing in the inner surface of each raceway groove shifts from each of raceway groove towards the shoulder as a result of displacement of the contact points of the rolling elements in the raceway groove inner surfaces towards the shoulder side.

In order to shape the grindstone used for processing the raceway grooves a rotary dressing machine may be used and, at the same time, the amount of projection of diamond grains in this rotary dressing machine may be greater than 0.1 mm, smaller than 0.5 mm. In this case, the grindstone has an excellent grinding property to the raceway grooves, and when the raceway grooves are to be ground by such a grindstone, it is possible to shorten the length of time required to complete the grinding, as compared with that afforded when the amount of protrusion of the diamond grains is equal to or smaller than 0.1 mm.

The raceway grooves may be processed by the use of a grindstone having a grain size not smaller than 40, but smaller than 70. In this case, it becomes possible to avoid an undesirable excessive temperature increase during the processing. The term “grain size” referred to above and hereinafter represents a numerical value descriptive of the size and the stepwise distribution of abrasive particles. The smaller the numerical value, the greater the grain size of the abrasive material. The number of perforations in a screen per square inch represents the grain size and, hence, the coarse grain is classified according to the sieve analysis and fine powder particles are classified according to the enlarged photographic method.

The raceway grooves may have a surface roughness within the range of Ra0.2 to 1.2 μm. This is because since the present application is used at an to extremely low speed, the surface roughness will not affect evolution of heat.

In the raceway groove processing method of the present invention, respective curvature of the mating raceway grooves in the inner and outer rings may be the same. In this case, a dresser for a grindstone used to grind the raceway grooves in the inner ring and a dresser for a grindstone used to grind the raceway grooves in the outer ring can be rendered to be the same.

The respective curvatures of the mating raceway grooves in the inner and outer rings, respectively, are the same and a dresser for a grindstone used to grind the raceway grooves in the inner ring and a dresser for a grindstone used to grind the raceway grooves in the outer ring may also be the same. In this case, the respective raceway grooves in the inner and outer rings can be processed under the same condition and, therefore, the relative difference between the inter-raceway groove distances can be theoretically reduced to zero. In the case of the swing bearing assembly having a large diameter of the pitch circles depicted by balls such as found in the swing bearing assembly used in the wind turbine, even though the same curvatures are chosen for the mating raceway grooves in the inner and outer rings, it brings little influence.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a sectional view showing a swing bearing assembly according to a preferred embodiment of the present invention;

FIG. 2A is a top plan view showing a grinding machine and a dressing device both employed in the manufacture of the swing bearing assembly;

FIG. 2B is a front elevational view of FIG. 2A:

FIG. 3A is a top plan view showing a grinding machine and a dressing device both employed in the manufacture of the swing bearing assembly, with those devices held in operative positions different from those shown in FIG. 2A;

FIG. 3B is a front elevational view of FIG. 3A:

FIG. 4A is a fragmentary enlarged sectional view showing an outer ring employed in the swing bearing assembly;

FIG. 4B is a fragmentary enlarged sectional view showing an inner ring employed in the swing bearing assembly;

FIG. 5 is a schematic diagram showing a grindstone and a rotary dressing machine both employed for processing raceway grooves in each of the inner and outer rings;

FIG. 6 is a fragmentary sectional view showing the rotary dressing machine;

FIG. 7 is a chart showing the relation between the relative difference between the inter-raceway groove distances and contact point stresses;

FIG. 8 is a perspective view showing an example of a wind turbine with a portion thereof cut out;

FIG. 9 is a broken-away side view of the wind turbine; and

FIG. 10 is a sectional view showing a schematic construction of a four point contact ball bearing assembly.

### BEST MODE FOR CARRYING OUT THE INVENTION

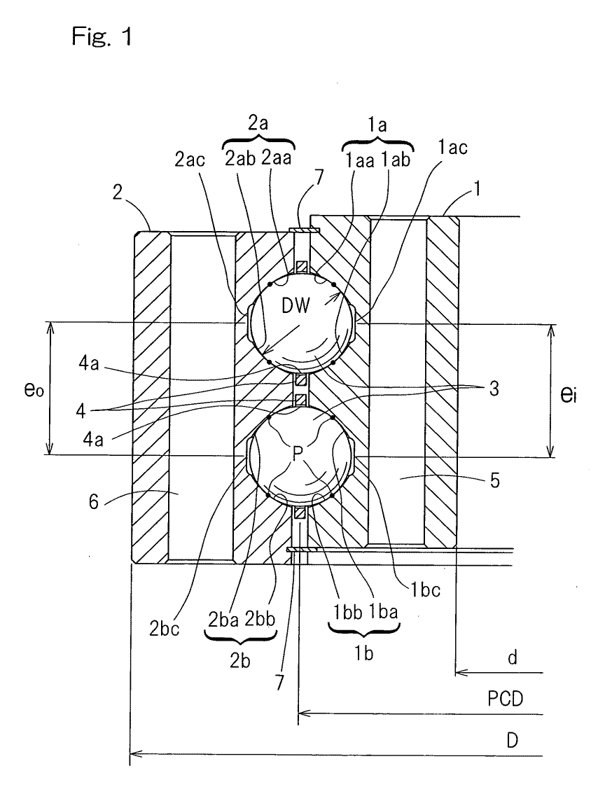

A preferred embodiment of the present invention will now be described in detail with particular reference to FIG. 1. A swing bearing assembly shown therein is used as, for example, a bearing assembly for supporting a blade assembly of a wind turbine for angular movement about an axis substantially orthogonal to the longitudinal axis of a main shaft, or a bearing assembly for supporting a nacelle of the wind turbine on a support base for angular movement.

The swing bearing assembly referred to above includes an inner ring 1 having double row raceway grooves 1a and 1b defined therein, an outer ring 2 having double row raceway grooves 2a and 2b defined therein, double row balls 3 interposed between the raceway grooves 1a and 1b in the inner ring 1 and the raceway grooves 2a and 2b in the outer ring 2, and a ball retainer 4 for retaining each row of the balls 3 with those balls 3 accommodated within respective pockets 4a in the retainer 4. Each of the raceway grooves 1a, 1b, 2a and 2b in the inner and outer rings 1 and 2 has two curved surfaces 1aa and 1ab, 1ba and 1bb, 2aa and 2ab, or 2ba and 2bb. The two curved surfaces forming the respective raceway groove 1a, 1b, 2a or 2b has a radius of curvature, which is greater than that of each of the balls 3, and represents an arcuate sectional shape having a different center of curvature. A portion of each of the raceway grooves 1a, 1b, 2a and 2b delimited between the pair of the curved surfaces forming the respective raceway groove is so formed and so shaped as to represent a grooved area 1ac, 1bc, 2ac or 2bc. Each of the balls 3 of each row is held in four point contact at P with the curved surfaces of the inner ring raceway groove 1a or 1b and the curved surfaces of the outer ring raceway groove 2a or 2b. In other words, the swing bearing assembly referred to in this embodiment is constructed as a four point contact, double row ball bearing assembly. The inner and outer rings 1 and 2 are provided with respective mounting bolt holes 5 and 6. A grease is filled within a bearing space delimited between the inner and outer rings 1 and 2 and axially spaced opposite ends of this bearing space are sealed by respective sealing members 7.

The bearing size is such that the inner diameter d thereof is within the range of 1,000 to 4,700 mm and the outer diameter D thereof is within the range of 1,300 to 5,000 mm. The balls 3 of both rows have the same diameter Dw, which is within the range of 30 to 80 mm. The respective curvatures of the curved surfaces 1aa and 1ab forming the inner ring raceway groove 1a and the respective curvatures of the curved surfaces 2aa and 2ab forming the outer ring raceway groove 2a are the same and equal to each other. This equally applies to the inner ring raceway groove 1b and the outer ring raceway groove 2b. The inter-raceway grove distances ei and eo in the inner and outer rings 1 and 2, respectively, are the same in the drawing board and are of a value satisfying such a relationship as Dw<ei(or, eo)<1.7 Dw. The inter-raceway groove distance ei (eo) referred to above and hereinafter means the distance measured between respective centers of two steel sample balls, identical in size to the balls 3 employed in the complete swing bearing assembly, when those two sample balls are urged to the raceway grooves 1a and 1b (2a and 2b), respectively, at two points (where the steel sample balls are held most closest to respective groove bottoms).

By way of example, when the inter-raceway groove distance ei in the inner ring 1 is to be measured, steel sample balls of the same size as the balls 3 employed in the complete swing bearing assembly are radially urged in the double row raceway grooves 1a and 1b. At this time, one of the steel sample balls are held in contact with the curved surfaces 1aa and 1ab at two points, respectively, whereas the other of the steel sample balls are held in contact with the curved surfaces 1ba and 1bb at two points, respectively. The shortest axial distance between those two steel sample balls so urged against the raceway grooves 1a and 1b is then measured. The inter-raceway groove distance ei can be obtained when the diameter of the steel sample balls is added to the shortest axial distance so measured. The inter-raceway groove distance eo in the outer ring 2 can be measured in a manner similar to that described in connection with the inter-raceway groove distance ei in the inner ring 1.

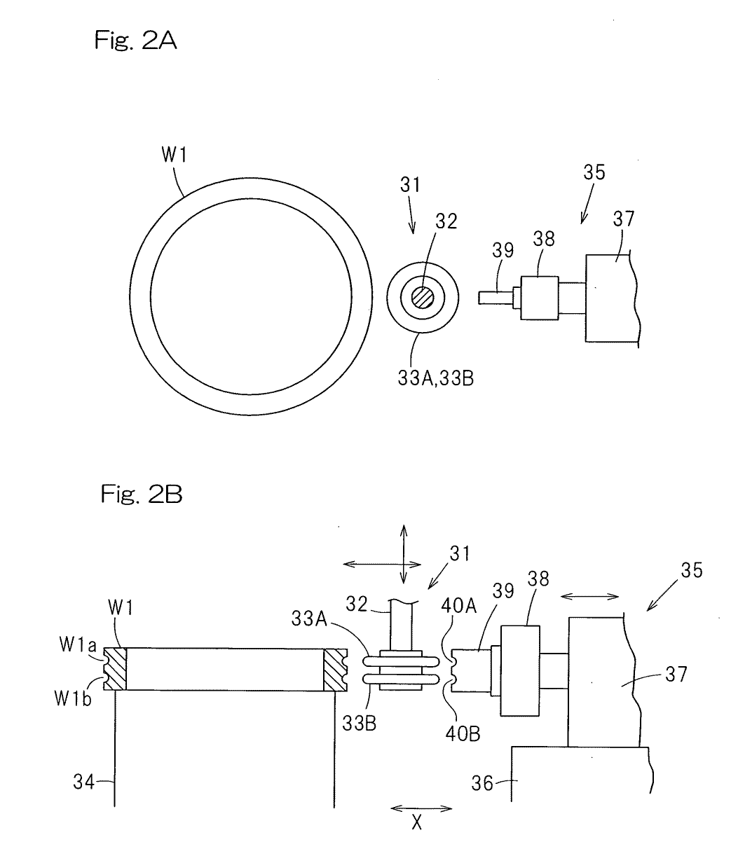

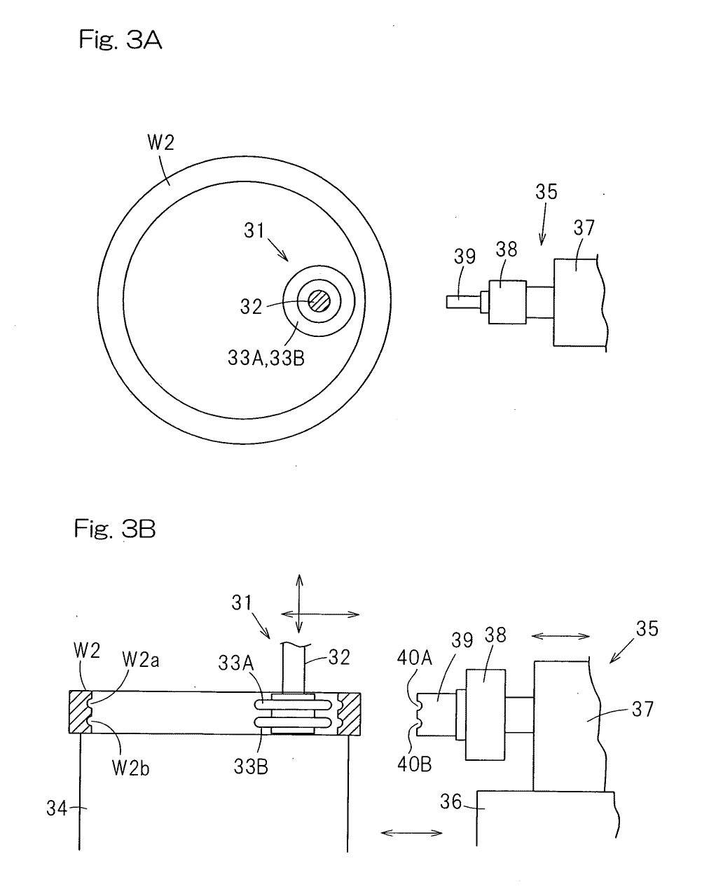

FIGS. 2A and 2B and FIGS. 3A and 3B illustrate a grinding machine for processing each of the raceway grooves employed in the swing bearing assembly and a dressing machine for dressing a grindstone used in the grinding machine. The grinding machine 31 shown therein includes two disc shaped grindstone 33A and 33B mounted on a grinder shaft 32, which is provided so as to depend vertically, and spaced a distance from each other. A rotary table 34 for supporting thereon workpieces W1 and W2, which eventually form the inner ring 1 and the outer ring 2, respectively, for rotation together therewith is disposed below the grinder shaft 32. The grindstones 33A and 33B have their outer peripheral portions having sectional shapes that are identical respectively with the sectional shapes of the inner ring raceway grooves 1a and 1b and the outer ring raceway grooves 2a and 2b. Also, the mounting spacing between the grindstones 33A and 33B is chosen to be equal to the inter-raceway groove distances ei and eo. The grinder shaft 32 is capable of being moved in a radial direction (X-axis direction) of the rotary table 34 within a distance ranging from a position (FIGS. 3A and 3B) immediately above the rotary table 34 to a position (FIGS. 2A and 2B) laterally displaced from the rotary table 34 and, also, being elevated up and down.

The dressing machine 35 includes a dresser body 37 mounted on a frame structure 36 so that the dresser body 37 can be driven in opposite directions, one at a time, that are parallel to the X-axis direction, a dresser head 38 protruding from the dresser body 37 in a direction towards the grinder shaft 32, and a grindstone dresser 39 fitted to the dresser head 38. The grindstone dresser 39 has dressing grooves 40A and 40B in which the corresponding grindstones 33A and 33B engage.

The workpiece W1, which eventually forms the inner ring 1, has its outer peripheral surface formed with two circumferentially extending grooves W1a and W1b by grinding. The raceway grooves 1a and 1b are processed by grinding those circumferentially extending grooves W1a and W1b with the disc shaped grindstones 33A and 33B. A method therefor includes, as shown in FIGS. 2A and 2B, positioning the disc shaped grindstones 33A and 33B at a predetermined height on an outer peripheral side of the workpiece W1 then supported on the rotary table 34, and advancing the disc shaped grindstones 33A and 33B towards the workpiece W1 while the rotary table 34 and the grinder shaft 32 are driven to rotate. By so doing, the disc shaped grindstones 33A and 33B grind respective portions of the workpiece W1 to form the circumferentially extending grooves W1a and W1b, thus tailoring the circumferentially extending grooves W1a and W1b to the intended shapes of the respective raceway grooves 1a and 1b simultaneously.

The workpiece W2, which eventually forms the outer ring 2, has its inner peripheral surface formed with two circumferentially extending grooves W2a and W2b by grinding. The raceway grooves 2a and 2b are processed by grinding those circumferentially extending grooves W2a and W2b with the disc shaped disc shaped grindstones 33A and 33B. A method therefor includes, as shown in FIGS. 3A and 3B, positioning the disc shaped grindstones 33A and 33B at a predetermined height on an inner peripheral side of the workpiece W2 then supported on the rotary table 34, and advancing the disc shaped grindstones 33A and 33B towards the workpiece W2 while the rotary table 34 and the grinder shaft 32 are driven to rotate. By so doing, the grindstones 33A and 33B grind respective portions of the workpiece W2 to form the circumferentially extending grooves W2a and W2b, thus tailoring the circumferentially extending grooves W2a and W2b to the intended shapes of the respective raceway grooves 2a and 2b simultaneously.

When the disc shaped grindstones 33A and 33B having their grinding surfaces that have been worn are to be dressed, the grinder shaft 32 has to be brought to a position laterally outwardly of the rotary table 34 (as shown in FIGS. 2A and 2B) and the dresser body 37 has to be then advanced towards the grinder shaft 32 then being rotated. By so doing, the respective outer peripheral portions of the disc shaped grindstones 33A and 33B are frictionally engaged in the respective dressing groove 40A and 40B of the disc shaped grindstone dresser 39 to thereby dress the disc shaped grindstones 33A and 33B simultaneously.

As hereinabove described, the double row circumferentially extending grooves W1a and W1b (W2a and W2b) of the workpiece W1 (workpiece W2) are simultaneously ground by the respective disc shaped grindstones 33A and 33B to process the respective raceway grooves 1a and 1b (2a and 2b), there is no possibility of occurrence of an error in mechanical accuracy and preciseness of a grindstone feeding for those double rows such as found in the case where those row raceway grooves in the inner and outer rings are processed separately in different process steps, and, hence, the preciseness of the inter-raceway groove distance ei (eo) is high. For this reason, the relative difference Δe between the inter-raceway groove distances ei and eo can be suppressed. In addition, simultaneous processing of the double row raceway grooves 1a and 1b (2a and 2b) results in a high processing efficiency.

In the case of the embodiment hereinabove described, since the curved surfaces 1aa and lab, 1ba and 1bb forming the innte raceway grooves 1a and 1b and the curved surfaces 2aa and 2ab, 2ba and 2bb forming the outer ring raceway grooves 2a and 2b have the same curvature, the grinding of the circumferentially extending grooves W1a and W1b of the workpiece W1 and the grinding of the circumferentially extending grooves W2a and W2b of the workpiece W2 can be accomplished with the use of the same grindstones 33A 33B and, also, the grindstones 33A and 33B can be dressed with the use of the same grindstone dresser 39. For this reason, the raceway grooves 1a, 1b and 2a, 2b of the inner and outer rings 1 and 2 can be processed under the same conditions and therefore, the relative difference Δe between the inter-raceway groove distances can be theoretically rendered zero. Also, in the swing bearing assembly, in which the diameter of the pitch circle depicted by the balls is large, such as, for example, the swing bearing assembly for use in the wind turbine, it brings little influence even when the curvatures of the mating raceway grooves 1a, 1b and 2a, 2b of the inner and outer rings 1 and 2 are chosen to be the same.

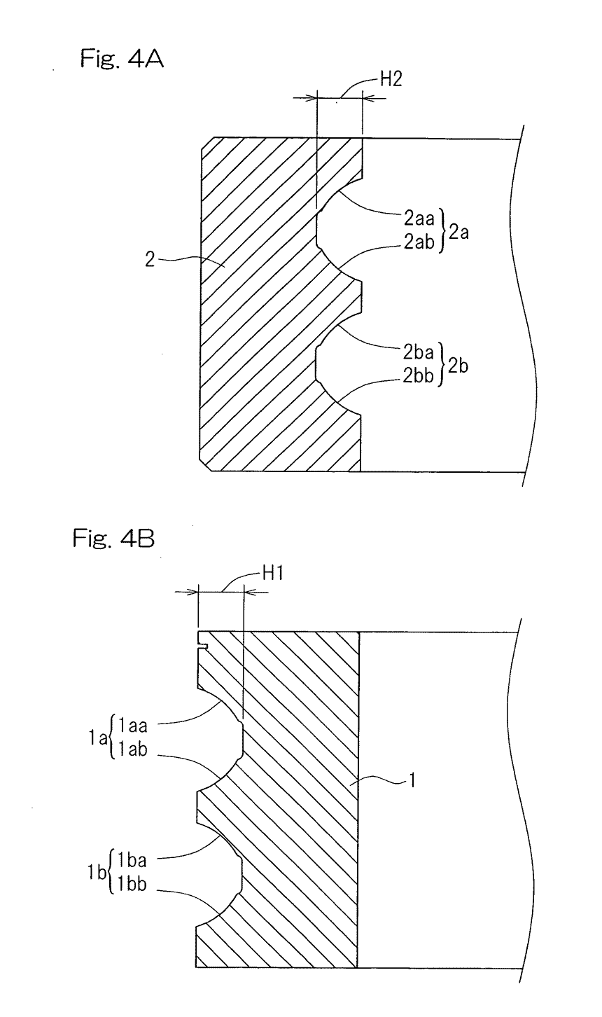

In the bearing type now under discussion, when an excessive axial load acts on the bearing assembly, there is a fear that as a result that rolling element contact points on the inner surfaces of raceway groove 1a, 1b, 2a and 2b (hereinafter referred to as “each raceway groove”) shift towards a shoulder side, the “shoulder run-on” phenomenon will occur, in which the contact ellipse appearing in the inner surface of each raceway groove shifts from each of raceway groove. For this reason, as shown in FIGS. 4A and 4B, the shoulder height H2 of each of the raceway grooves 2a and 2b in the outer ring 2 and the shoulder height H1 of each of the raceway grooves 1a and 1b in the inner ring 1 have to be chosen large. On the other hand, where the raceway grooves 1a and 1b, 2a and 2b are to be ground with the use of the grindstones 33A and 33B, points of contact of the grindstones 33A and 33B shift to approach from an outer diametric portion, at which the peripheral velocity is high, towards an end face, at which the peripheral velocity is low, as the shoulder height H1 and H2 of each of the raceway grooves increases, and, therefore, there is a risk of an excessive temperature increase during the grinding. For this reason, necessity is considered to take care in selecting the material and the grain size of the grindstones 33A and 33B and conditions of the dresser.

In the practice of the raceway groove processing method according to the present invention, such a rotary dresser RD as shown in FIG. 5, for example, is used in forming the grindstones 33A and 33B for use in processing the raceway grooves 1a and 1b (2a and 2b). The rotary dresser RD shown therein is formed to represent, for example, a substantially hollow cylindrical shape and is used in the form as mounted on a rotary shaft (not shown). While the outer peripheral portions of the disc shaped grindstones 33A and 33B are engaged in respective dressing grooves 40A and 40B formed in an outer periphery of the rotary dresser RD, the rotary shaft referred above is driven to rotate so that the grindstones 33A and 33B having their grinding surfaces, which have been worn, can be dressed simultaneously.

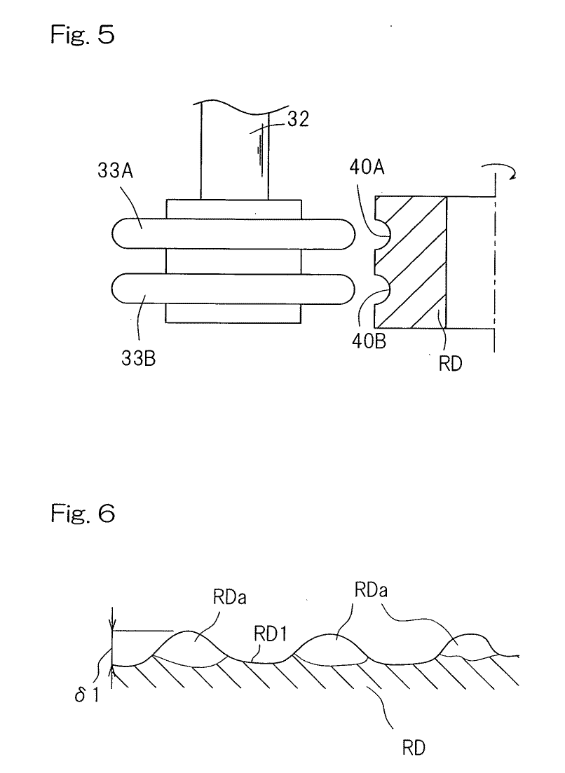

As shown in FIG. 6, the rotary dresser RD has a diamond grain RDa that protrudes a protruding amount δ1 so chosen as to be greater than 0.1 mm, but smaller than 0.5 mm. In the illustrated embodiment, the protruding amount δ1 is chosen to be, for example, 0.2 mm. The rotary dresser RD is prepared with a plurality of diamond grains RDa provided on a surface RD1 of a “binding material” so as to protrude therefrom.

The “protruding amount δ1 of the diamond grain RDa” is intended to means an average amount of protrusion per grindstone grain that protrudes from the surface RD1 of the binding material in a direction radially outwardly.

The grindstones 33A and 33B shaped with the use of the rotary dresser RD of the type referred to above is preferably an alundum series material for processing the inner and outer rings 1 and 2 which are a ferrous series material. The term “alundum” is synonymous with an aluminum series abrasive grains and this alumina series abrasive grains include as material species, for example, Corundum, Mono-crystalline Grains, Pink Corundum, White Corundum and Emery.

The Corundum referred to above is of a kind prepared by smelting alumina mineral ores within an electric furnace under a reducing atmosphere to increase the alumina content, followed by pulverizing and sizing the resultant block and includes a dark brown amorphous component and a corundum crystal having a certain quantity of titanium oxide. The Mono-crystalline Grains referred to above is of a kind prepared by melting an alumina raw material within an electric furnace, followed by pulverizing and sizing the resultant block by means of a method without recourse to the standard mechanical pulverization and includes corundum of a single crystal. The Pink Corundum referred to above is of a kind prepared by melting an alumina raw material within an electric furnace with a certain quantity of chromium oxide added thereto, followed by pulverizing and sizing the resultant block and includes a dark rose corundum crystal. The White Corundum referred to above is of a kind prepared by melting a high purity alumina within an electric furnace, followed by pulverizing and sizing the resultant block and includes a pure white corundum crystal. The Emery referred to above is of a kind prepared by smelting alumina mineral ores within an electric furnace under a reducing atmosphere followed by pulverizing and sizing the resultant gray-black block and includes corundum crystal, mullite crystal and others.

In the practice of the raceway groove processing method according to the present invention, for the grindstones 33A and 33B containing the alundum referred to previously, grindstones having a grain size of not smaller than 40, but smaller than 70, for example, grindstones having a grain size of 54 were employed. Also, the raceway grooves 1a, 1b, 2a and 2b had a surface roughness within the range of Ra0.2 to 1.2 μm.

As a comparative example, grindstones made of a ceramic material were shaped with the use of the rotary dresser RD of the type discussed above, in which the protruding amount δ1 of the diamond grains RDa of the rotary dresser RD was chosen to be 0.1 mm. Regarding the grain size of those grindstones, the grain size of 70 was chosen. When the raceway grooves 1a and 1b (2a and 2b) were processed with those grindstones, it occurred that the raceway grooves 1a and 1b (2a and 2b) involved an excessive temperature rise.

When the raceway grooves 1a and 1b (2a and 2b) had been processed with the grindstones containing alundum according to this embodiment and having the grain size of 54, as the shoulder heights H1 and H2 of the raceway grooves 1a and 1b (2a and 2b) increased, contact points of the grindstones 33A and 33B approached from the outer diametric portion, at which the peripheral velocity was high, towards the end face, at which the peripheral velocity was low. However, the use of the grindstones 33A and 33B, which had been shaped with the use of the rotary dresser RD, in which the amount of protrusion of the diamond grains RDa was not smaller than 0.1 mm, but smaller than 0.5 mm and which contained alundum and had a grain size not smaller than 40, but smaller than 70 made it possible to prevent the excessive temperature rise during the processing of the raceway grooves 1a and 1b (2a and 2b).

It is to be noted that although if the material and the grain size of the grindstones 33A and 33B and the conditions of the dresser are chosen for avoiding the excessive temperature rise occurring during the processing of the raceway grooves 1a and 1b (2a and 2b), the surface roughness of the raceway grooves 1a and 1b (2a and 2b) will become rough, the product according to the present invention is generally used at an extremely low speed of 1 min⁻¹ and, therefore, the use can be made without being accompanied by a problem associated with evolution of heat.

Since the swing bearing assembly of the present invention is in the form of the four point contact ball bearing and with the balls 3 arranged in double rows, the load rating is high while the structure is simplified. By simple arithmetic, the load rating is double as compared with a single row ball bearing assembly.

Also, by simultaneously processing the double row raceway grooves 1a and 1b, 2a and 2b of the inner and outer rings 1 and 2, the relative distance Δe between the inter-raceway groove distances can be minimized and the increased lifetime can be achieved with the load uniformly loaded on the rows of the raceway grooves 1a and 1b, 2a and 2b. The smaller the relative distance Δe between the inter-raceway groove distances, the better, but if this is pursued too much, the productivity will be lowered and the cost will increase. In view of this, as a result of comparison between the bearing lifetime and one or both of the productivity and the cost, the relative difference Δe between the inter-raceway groove distances in the swing bearing assembly of the bearing size and specification hereinbefore employed is chosen to be within the range of 5 to 50

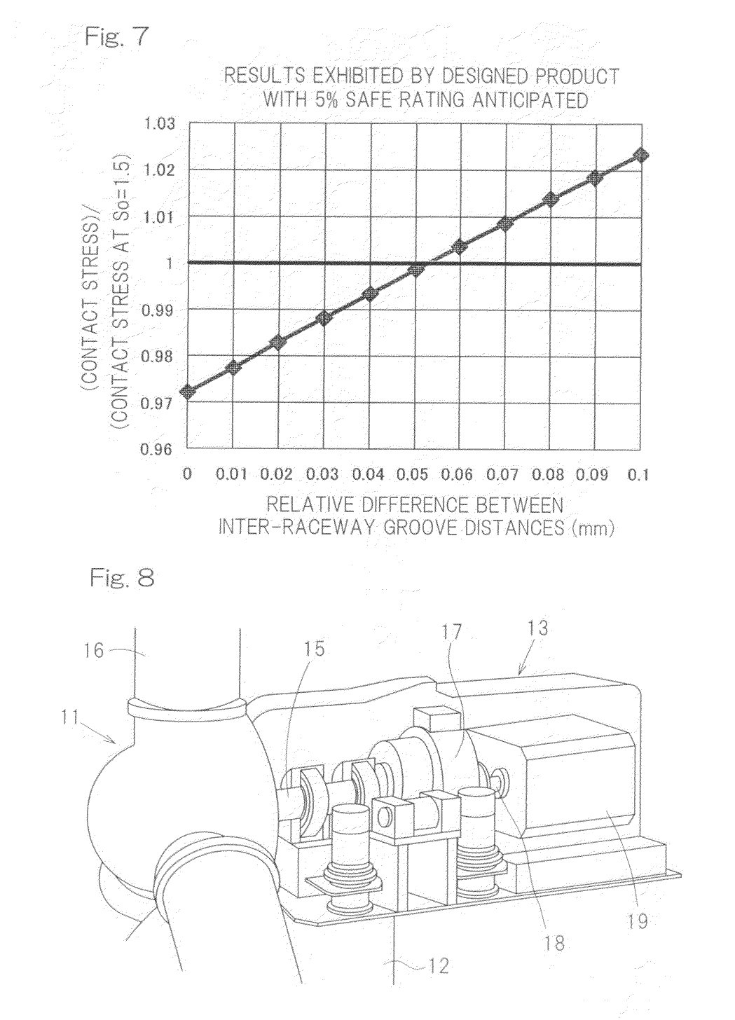

The basis therefor will now be discussed. In the swing bearing assembly of a bearing size and a specification that are discussed hereinbefore, a plurality of swing bearing assemblies having different relative differences Δe between the inter-raceway groove distances were manufactured and stresses acting on the contact points P in the inner and outer rings 1 and 2 of each of those swing bearing assemblies were then measured. In general, the swing bearing assembly for the support of the blade assembly of the wind turbine is internally designed to have a safety coefficient So which is equal to or smaller than 1.5 (So≧1.5). This is so defined as discussed above in Germanisher Lloyd GL, which is largely recognized as a certified precision of the wind turbine. It is to be noted that the safety coefficient So is expressed by So=Co/Pomax (wherein Co represents the basic static load rating and Pomax represents the maximum static equivalent load). Results exhibited by the designed product (designed to have So=1.58 at maximum load) with 5% safe rating anticipated are shown in the chart of FIG. 7. It has been revealed that when the relative difference Δe between the inter-raceway groove distances was smaller than 5 μm, the productivity was reduced and the cost increased to such an extent that the product did no longer pay, but when the relative difference Δe between the inter-raceway groove distances is greater than 50 μm, that is, when a value on axis of ordinate in FIG. 7 is greater than 1, a problem would occur in the lifetime of the swing bearing assembly. In view of this, it is concluded that the relative difference between the inter-raceway groove distances should be within the range of 5 to 50 μm. In particular, control of the relative difference between the inter-raceway groove distances is important in reducing the weight of the bearing assembly.

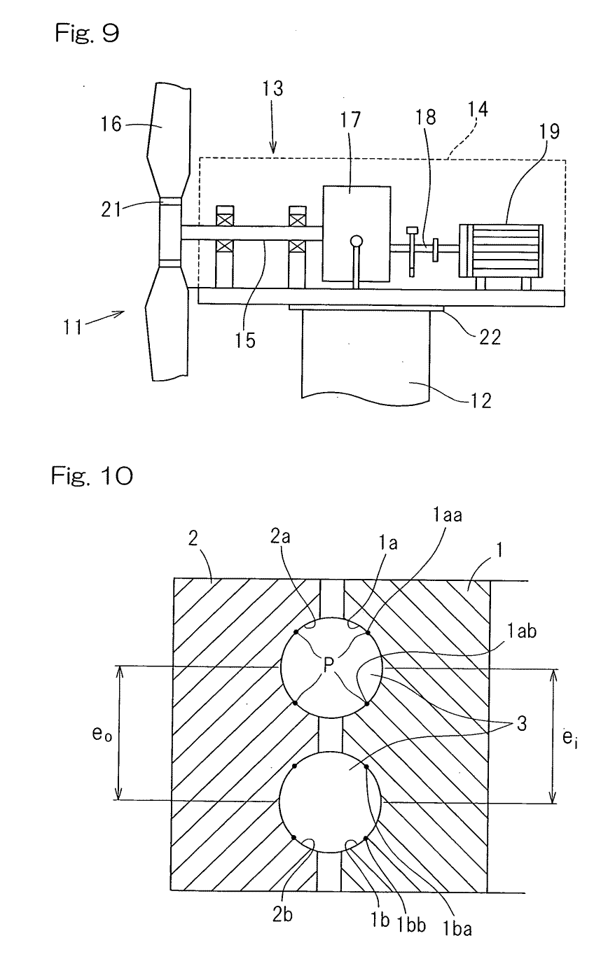

As hereinabove discussed, since the swing bearing assembly is simple in structure with a large load rating, relatively low in cost and long in lifetime, it is suited for use as the swing bearing assembly 21 (FIG. 9) for the support of the blade assembly in the wind turbine and the swing bearing assembly 22 (FIG. 9) for the yaw support of the nacelle. In the field other than that of the wind turbine used in the wind power generation, it can be employed in construction machines such as, for example, a hydraulic shovel and a crane, a rotary table in a machine tool and a parabola antenna and so on.

While the raceway groove grinding machine 31 employed in the foregoing preferred embodiment of the present invention is so designed that the circumferentially extending grooves W1a and W1b of the workpieces W1, which eventually forms the inner ring, and the circumferentially extending grooves W2a and W2b of the workpieces W2, which eventually forms the outer ring, are ground by the same grindstones 33A and 33B, they may be ground with the use of different grindstones. Even in such case, by allowing both grindstones to be dressed by the same grindstone dresser 39, the raceway grooves 1a, 1b and 2a, 2b in the inner and outer rings 1 and 2 can be processed under the same processing conditions. A method may be employed in which after the grooves 40A and 40B of the dresser groove 39 have been prepared separately, upper and lower end faces of the grooves 40A and 40B are overlapped.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

1: Inner ring
1a, 2b: Inner ring raceway groove
2: Outer ring
2a, 2b: Outer ring raceway groove
3: Ball
4: Ball retainer
21, 22: Swing bearing assembly
31: Grinding machine
33A, 33B: Grindstone
35: Dressing machine
39: Grindstone dresser
Dw: Diameter of the ball
ei: Inter-raceway groove distance in the inner ring
eo: Inter-raceway groove distance in the outer ring
Δe: Relative difference between the inter-raceway groove distances
RD: Rotary dresser
RDa: Diamond grain
δ1: Protruding amount

What is claimed is:

1. A swing bearing assembly, which comprises an inner ring having double row raceway grooves defined therein, an outer ring having double row raceway grooves defined therein, a plurality of balls interposed between the double row raceway grooves in the inner ring and the double row raceway grooves in the outer ring, respectively,
in which each of the inner and outer rings is of one-piece construction and the difference between the distance from one row of the raceway groove in the inner ring to another row of the raceway groove in the inner ring and the distance from one row of the raceway groove in the outer ring to another row of the raceway groove in the outer ring is chosen to be not greater than 50 μm.

2. The swing bearing assembly as claimed in claim 1, in which the distance between the double row raceway grooves in the inner ring or the distance between the double row raceway grooves in the outer ring is chosen to fall within the range of a value equal to the diameter of each of the ball to a value that is 1.7 times the diameter of each of the balls and each of the balls has a diameter within the range of 30 to 80 mm.

3. A method of processing double row raceway grooves in a swing bearing assembly, in which the double row raceway grooves are formed in each of inner and outer rings, which is of one-piece structure, and a plurality of balls are interposed between the double row raceway grooves in the inner ring and the double row raceway grooves in the outer ring, respectively, and in which the double row raceway grooves in the inner ring and the double row raceway grooves in the outer ring are simultaneously processed to reduce the difference between the distance from one row of the raceway groove in the inner ring to another row of the raceway groove in the inner ring and the distance from one row of the raceway groove in the outer ring to another row of the raceway groove in the outer ring to a value equal to or smaller than 50 μm.

4. The raceway groove processing method for the swing bearing assembly as claimed in claim 3, in which the distance from one row of the raceway groove in the inner ring to another row of the raceway groove in the inner ring or the distance from one row of the raceway groove in the outer ring to another row of the raceway groove in the outer ring is chosen to fall within the range of a value equal to the diameter of each of the ball to a value that is 1.7 times the diameter of each of the balls and each of the balls has a diameter within the range of 30 to 80 mm.

5. The raceway groove processing method for the swing bearing assembly as claimed in claim 3, in which the raceway grooves are processed by the use of an alundum series grindstone.

6. The raceway groove processing method for the swing bearing assembly as claimed in claim 5, in which a rotary dressing machine is used to shape the grindstone used for processing the raceway grooves and the amount of projection of diamond grains in this rotary dressing machine is greater than 0.1 mm, smaller than 0.5 mm.

7. The raceway groove processing method for the swing bearing assembly as claimed in claim 3, in which the raceway grooves are processed by the use of a grindstone having a grain size not smaller than 40, but smaller than 70.

8. The raceway groove processing method for the swing bearing assembly as claimed in claim 3, in which the raceway grooves have a surface roughness within the range of Ra0.2 to 1.2 μm.

9. The raceway groove processing method for the swing bearing assembly as claimed in claim 3, in which respective curvature of the mating raceway grooves in the inner and outer rings are the same.

10. The raceway groove processing method for the swing bearing assembly as claimed in claim 9, in which a dresser for a grindstone used to grind the raceway grooves in the inner ring and a dresser for a grindstone used to grind the raceway grooves in the outer ring are the same.
